(19) United States
(12) Patent Application Publication
(10) Pub. No.: US 2023/0141827 A1
(43) Pub. Date: May 11, 2023

(54) ARRANGEMENT OF PEDESTALS OF VARYING ASPECT RATIO FOR DUAL-WALL COOLING OF AN AIRFOIL

(71) Applicants: Rolls-Royce Corporation, Indianapolis, IN (US); Rolls-Royce North American Technologies Inc., Indianapolis, IN (US)

(72) Inventors: Brett J. Barker, Indianapolis, IN (US); Eric Koenig, Indianapolis, IN (US); Jerry Layne, Indianapolis, IN (US); Jeffrey F. Rhodes, Indianapolis, IN (US)

(73) Assignees: Rolls-Royce Corporation, Indianapolis, IN (US); Rolls-Royce North American Technologies Inc., Indianapolis, IN (US)

(21) Appl. No.: 17/520,226

(22) Filed: Nov. 5, 2021

(51) Int. Cl. F01D 25/12; F01D 9/02

(52) U.S. Cl. CPC F01D 25/12; F01D 9/02; F05D 2220/32; F05D 2240/12; F05D 2260/202

(57) ABSTRACT

A dual-wall airfoil comprises a spar including pressure and suction side walls with raised features on outer surfaces thereof. A pressure side coversheet has an inner surface in contact with the raised features on the outer surface of the pressure side wall so as to define pressure side flow pathways between the pressure side wall and the pressure side coversheet, and a suction side coversheet has an inner surface in contact with the raised features on the outer surface of the suction side wall so as to define suction side flow pathways between the suction side wall and the suction side coversheet. The raised features on the outer surface of the pressure and/or suction side wall include an arrangement of pedestals, where each pedestal comprises an aspect ratio in a range from about 1:1 to about 5:1. The aspect ratio of the pedestals is varied within the arrangement.

### TECHNICAL FIELD

This disclosure relates generally to airfoils with dual-wall cooling and more particularly to a pedestal arrangement for dual-wall cooling of an airfoil.

### BACKGROUND

Gas turbine engines include a compressor, combustor and turbine in flow series along a common shaft. Compressed air from the compressor is mixed with fuel in the combustor to generate hot combustion gases that rotate the turbine blades and drive the compressor. Improvements in the thrust and efficiency of gas turbine engines are linked to increasing turbine entry temperatures, which places a heavy burden on turbine blades. Consequently, there is significant interest in developing improved cooling techniques for airfoils in gas turbine engines. Dual-wall or double-wall cooling configurations are promising advancements for the cooling of turbine blades.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is an exploded assembly view of an exemplary airfoil with dual-wall cooling that includes an exemplary arrangement of pedestals of varying aspect ratios.

FIG. 2 is a close-up view of part of the arrangement of pedestals shown in FIG. 1.

FIG. 3 is a cross-sectional view of an exemplary gas turbine engine that may include the airfoil described in this disclosure.

### DETAILED DESCRIPTION

A dual-wall or double-wall airfoil for a gas turbine engine may include a hollow spar that is partially or completely surrounded by suction side and pressure side coversheets (or “skins”) and spaced apart from the coversheets by raised features on the outer surface of the spar. These raised features may include pedestals and/or rails arranged to define flow pathways for coolant (e.g., air) between the outer surface of the spar and the respective coversheet. The coolant may provide heat transfer and cooling as it traverses the flow pathways before exiting, typically through exit holes in the respective coversheet or through exit slots. After exit, the coolant may flow in a layer over a hot external surface of the airfoil, providing film cooling. The coolant is delivered into the flow pathways from one or more coolant cavities in the spar. Traditional square pedestal arrays can provide high heat transfer, but may also generate a large pressure drop that is generally not desirable for long flow pathways. Smooth, straight rails tend to be associated with a lower pressure drop, but they may be unable to provide sufficient heat transfer and may be susceptible to being blocked with particulate debris. It is also important to manage the temperature of the coolant, since, as the coolant absorbs heat and increases in temperature, it may become less effective at cooling the airfoil.

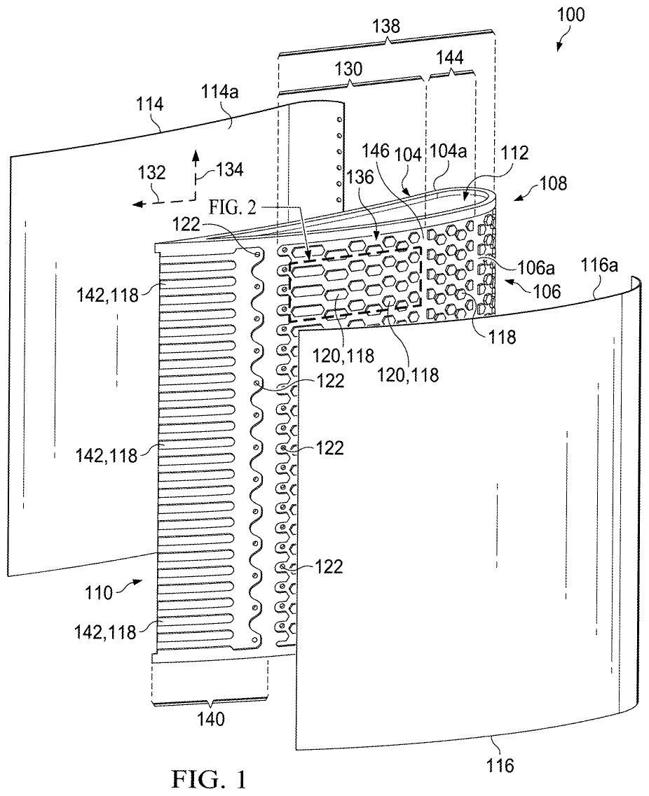

FIG. 1 illustrates an airfoil with dual-wall cooling for a gas turbine engine that may provide advantages over previous designs by utilizing raised features having different aspect ratios. The airfoil 100 comprises a spar 102 having a pressure side wall 104 and a suction side wall 106 meeting at a leading edge 108 and a trailing edge 110 of the airfoil 100. Each of the pressure side wall 104 and the suction side wall 106 includes raised features 118 on an outer surface 104a,106a thereof. It is noted that the suction side of the airfoil 100 is shown in FIG. 1 and thus the raised features 118 on the pressure side wall 104a are not visible. A pressure side coversheet 114 overlies the pressure side wall 104, and an inner surface 114a of the pressure side coversheet 114 is in contact with (e.g., bonded to or integrally formed with) the raised features 118 on the outer surface 104a of the pressure side wall 104, thereby defining pressure side flow pathways between the pressure side wall 104 and the pressure side coversheet 114. A suction side coversheet 116 overlies the suction side wall 106, and an inner surface 116a of the suction side coversheet 116 is in contact with (e.g., bonded to or integrally formed with) the raised features 118 on the outer surface 106a of the suction side wall 106, thereby defining suction side flow pathways between the suction side wall 106 and the suction side coversheet 116. An interior of the spar 102 includes one or more coolant cavities 112 for providing coolant to the pressure side and suction side flow pathways through inlet holes 122 in the pressure and suction side walls 104,106.

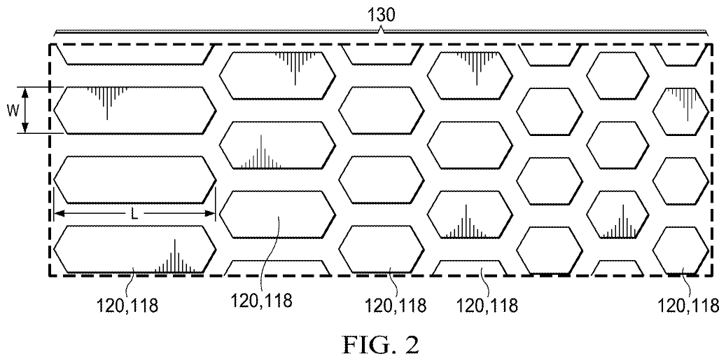

The raised features 118 on the outer surface 104a of the pressure side wall 104 and/or the suction side wall 106 may include an arrangement 130 of pedestals 120 having different aspect ratios, where each pedestal 120 has an aspect ratio in the range from about 1:1 to about 5:1. The aspect ratio is equivalent to the length L (long axis) divided by the width W (short axis) of the pedestal, as illustrated in FIG. 2. Advantageously, in order to control heat transfer, coolant temperature, and pressure drop, the aspect ratio of the pedestals 120 is varied within the arrangement. For example, the aspect ratio may increase and/or decrease across the arrangement 130, as shown in FIG. 2, where the pedestals 120 transition from an aspect ratio of about 3.5:1 to an aspect ratio of about 1:1 moving from left to right across the schematic, which corresponds to a chordal direction 132, as shown in FIG. 1. The increase and/or decrease in aspect ratio within the arrangement 130 may be described by a linear, quadratic, exponential, step or other function.

The pedestals 120 in the arrangement 130 and the raised features 118 in general may have a height that corresponds to the spacing between the outer surface 104a,106a of the side wall 104,106 and the respective coversheet 114,116. The pedestals 120 may have a cross-sectional shape that is described as hexangular, or as a stretched hexagon, when the aspect ratio is greater than 1:1. An aspect ratio of greater than 1:1 may alternatively be achieved with a cross-sectional shape described as an elongated diamond, where the elongated diamond comprises two (opposing) included angles of greater than 90 degrees and two (opposing) included angles of less than 90 degrees. If the aspect ratio is 1:1 or about 1:1, the cross-sectional shape may be a hexagonal or diamond shape.

The aspect ratio may be varied along a predetermined direction, such as along the chordal direction 132 or along the radial direction 134, or along a direction having both chordal and radial components. In one example, it may be beneficial for the aspect ratio of the pedestals 120 to increase toward the trailing edge 110 and/or the leading edge 108 of the airfoil 100. Also or alternatively, the aspect ratio may decrease toward a midspan 136 of the airfoil 100, where heat may be concentrated. Some adjacent pedestals 120 may have the same aspect ratio along the direction of variation; i.e., there may be some local regions where the aspect ratio remains unchanged as part of an overall increasing or decreasing trend. Preferably, the long axes of the pedestals 120 are aligned with the direction of coolant flow, which may be the chordal direction 132, as illustrated, the radial direction 134, or a direction having both chordal and radial components.

As shown in FIGS. 1 and 2, the aspect ratio may vary (increase and/or decrease) along the direction of coolant flow. The pedestals 120 may be arranged and sized such that adjacent flow paths merge and/or split at the same transverse location, that is, along the same line perpendicular to the flow paths, as shown for example in FIGS. 1 and 2, where the flow paths in this example are along the chordal direction 134. By choosing a suitable arrangement and aspect ratio for the pedestals 120, uniform flow can be achieved and distortions in flow intersections may be avoided. It is contemplated that such distortions may be minimized for situations in which the adjacent flow paths do not merge and/or split at the same transverse location by incorporating a slow (linear) transition or by incorporating a fast (step change) transition in aspect ratio. For example, a higher aspect ratio pedestal may have a length which is a multiple of the length of an adjacent (e.g., a radially adjacent) lower aspect ratio pedestal.

The arrangement 130 of pedestals 120 may be on the outer surface 104a of the pressure side wall 104 and/or on the outer surface 106a of the suction side wall 106. In one example, as shown in FIG. 1, a midspan cooling circuit 138 on the suction side of the airfoil 100 may include the arrangement 130 of pedestals 120. The midspan cooling circuit 138 may be configured to deliver coolant to the leading edge 108 of the airfoil 100, and may be adjacent to a trailing edge cooling circuit 140 configured to deliver coolant to the trailing edge 110 of the airfoil 100. The midspan and trailing edge cooling circuits 138,140 may be separated by a radial dam between the inlet holes 122 that deliver coolant to each circuit 138,140. The raised features 118 of the trailing edge cooling circuit 140 typically comprise rails 142, which may be understood to have an aspect ratio (length:width) greater than 5:1, such as up to 10:1, or higher. The arrangement 130 of pedestals 120 may extend in the direction of the leading edge 108 over just part of the midspan cooling circuit 138 and may be separated from a section 144 of raised features 118 positioned nearer to the leading edge 108 by a radial spacing 146 on the outer wall 106a, as shown in FIG. 1. The section 144 of raised features 118 may or may not include pedestals 120 of varying aspect ratio. The radial spacing 146 may be a consequence of the casting process to fabricate the airfoil 100, where multiple dies may be employed, although the airfoil 100 is not limited to this fabrication method. The arrangement 130 of pedestals 120 having the variable aspect ratio may extend over (only) a portion of the midspan cooling circuit 138 in a chordal direction, as shown, and/or in a radial direction. In such examples, the arrangement 130 may be adjacent to one or more other arrangements of raised features (e.g., pedestals or rails) 118 which may not exhibit a spatial variation in aspect ratio.

In other examples, the arrangement 130 of pedestals 120 of varying aspect ratio may extend over an entirety of the midspan cooling circuit 138 in one or both of the chordal and radial directions 132,134. It is also contemplated that the arrangement 130 of pedestals 120 may extend over an entirety of the suction side wall 106 and/or the pressure side wall 104 of the airfoil 100. In one such example, a first cooling circuit configured to deliver coolant to the leading edge 108 may include a first part of the arrangement 130 and a second cooling circuit configured to deliver coolant to the trailing edge 110 of the airfoil 100 may include a second part of the arrangement 130, where the aspect ratio of the pedestals 120 in each of the first and second parts of the arrangement 130 may be varied to control heat transfer and pressure drop as needed.

The dual-wall airfoil 100 described herein may be fabricated using investment casting and diffusion bonding methods known in the art, such as described in U.S. Pat. No. 6,003,754, entitled “Airfoil for a Gas Turbine Engine and Method of Manufacture,” which is hereby incorporated by reference in its entirety. The airfoil 100, including the spar 102 and the pressure and suction side coversheets 114,116, may be formed from one or more materials that have high melting points, good oxidation/corrosion resistance and high-temperature strength. For example, a nickel-base alloy, a titanium-base alloy, and/or an iron-base alloy may be suitable. The alloy may have an equiaxed, directionally solidified, or single-crystal microstructure. The raised features 118 may be integrally formed with the spar 102, or, more specifically, may be integrally formed on the respective suction or pressure side wall 106,104. The raised features 118 may be bonded to or integrally formed with the respective suction or pressure side coversheet 114,116. The airfoil 100 may have a single-piece or a multi-piece construction.

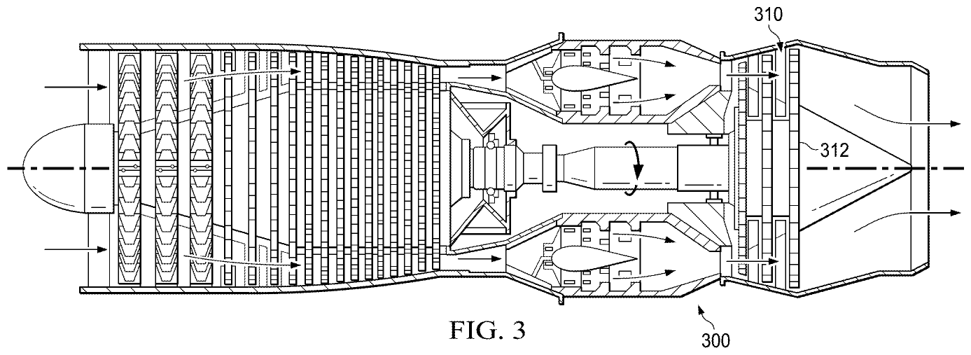

A gas turbine engine 300, such as that shown in FIG. 3, may include the airfoil 100 described above, e.g., as a nozzle guide vane or a turbine blade 312 in the turbine section 310. In some examples, the gas turbine engine 300 may supply power to and/or provide propulsion of an aircraft, e.g., a helicopter, an airplane, an unmanned space vehicle, a fixed wing vehicle, a variable wing vehicle, a rotary wing vehicle, an unmanned combat aerial vehicle, a tailless aircraft, a hover craft, and/or an extraterrestrial (spacecraft) vehicle. Also or alternatively, the gas turbine engine 300 may be utilized in a configuration unrelated to an aircraft such as, for example, an industrial application, an energy application, a power plant, a pumping set, a marine application (for example, for naval propulsion), a weapon system, a security system, a perimeter defense or security system.

To clarify the use of and to hereby provide notice to the public, the phrases “at least one of <A>, <B>, . . . and <N>” or “at least one of <A>, <B>, . . . or <N>” or “at least one of <A>, <B>, <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to an airfoil including an arrangement of pedestals of varying aspect ratio for dual-wall cooling, the airfoil comprising: a spar having a pressure side wall and a suction side wall meeting at a leading edge and a trailing edge of the airfoil, each of the pressure side wall and the suction side wall including raised features on an outer surface thereof, an interior of the spar including one or more coolant cavities; and a pressure side coversheet overlying the pressure side wall, an inner surface of the pressure side coversheet being in contact with the raised features on the outer surface of the pressure side wall, thereby defining pressure side flow pathways between the pressure side wall and the pressure side coversheet, the pressure side flow pathways being in fluid communication with the one or more coolant cavities; a suction side coversheet overlying the suction side wall, an inner surface of the suction side coversheet being in contact with the raised features on the outer surface of the suction side wall, thereby defining suction side flow pathways between the suction side wall and the suction side coversheet, the suction side flow pathways being in fluid communication with the one or more coolant cavities, wherein the raised features on the outer surface of the pressure side wall and/or the suction side wall include an arrangement of pedestals, each pedestal comprising an aspect ratio in a range from about 1:1 to about 5:1, and wherein the aspect ratio of the pedestals is varied within the arrangement.

A second aspect relates to the airfoil of the first aspect, wherein the pedestals in the arrangement have a cross-sectional shape selected from the group consisting of diamond, elongated diamond, hexagonal, and hexangular.

A third aspect relates to the airfoil of the first or second aspect, wherein the arrangement of pedestals is on the outer surface of the pressure side wall.

A fourth aspect relates to the airfoil of any preceding aspect, wherein the arrangement of pedestals is on the outer surface of the suction side wall.

A fifth aspect relates to the airfoil of any preceding aspect, wherein the aspect ratio increases and/or decreases across the arrangement.

A sixth aspect relates to the airfoil of any preceding aspect, wherein the aspect ratio is varied along a chordal direction.

A seventh aspect relates to the airfoil of any preceding aspect, wherein the aspect ratio is varied along a radial direction.

An eighth aspect relates to the airfoil of any preceding aspect, wherein the aspect ratio is varied along a direction having a chordal component and a radial component.

A ninth aspect relates to the airfoil of any preceding aspect, wherein the aspect ratio decreases toward a midspan of the airfoil.

A tenth aspect relates to the airfoil of any preceding aspect, wherein the aspect ratio increases toward a trailing edge and/or a leading edge of the airfoil.

An eleventh aspect relates to the airfoil of any preceding aspect, wherein long axes of the pedestals are aligned with a direction of coolant flow over the respective outer surface.

A twelfth aspect relates to the airfoil of any preceding aspect, wherein long axes of the pedestals are aligned with a chordal direction.

A thirteenth aspect relates to the airfoil of any preceding aspect, wherein long axes of the pedestals are aligned with a radial direction.

A fourteenth aspect relates to the airfoil of any preceding aspect, wherein long axes of the pedestals are aligned with a direction having a chordal component and a radial component.

A fifteenth aspect relates to the airfoil of any preceding aspect, wherein a midspan cooling circuit configured to deliver coolant to the leading edge of the airfoil includes the arrangement of pedestals.

A sixteenth aspect relates to the airfoil of the fifteenth aspect, wherein the arrangement of pedestals extends over an entirety of the midspan cooling circuit.

A seventeenth aspect relates to the airfoil of the fifteenth aspect, wherein the arrangement of pedestals extends over just part of the midspan cooling circuit and is separated from a section of raised features positioned nearer to the leading edge by a radial spacing on the respective outer wall.

An eighteenth aspect relates to the airfoil of the fifteenth aspect, wherein the arrangement of pedestals is adjacent to a trailing edge cooling circuit configured to deliver coolant to the trailing edge of the airfoil, wherein the raised features of the trailing edge cooling circuit comprise rails.

A nineteenth aspect relates a gas turbine engine including the airfoil of any preceding aspect.

In addition to the features mentioned in each of the independent aspects enumerated above, some examples may show, alone or in combination, the optional features mentioned in the dependent aspects and/or as disclosed in the description above and shown in the figures.

1. An airfoil including an arrangement of pedestals of varying aspect ratio for dual-wall cooling, the airfoil comprising:
a spar having a pressure side wall and a suction side wall meeting at a leading edge and a trailing edge of the airfoil, each of the pressure side wall and the suction side wall including raised features on an outer surface thereof, an interior of the spar including one or more coolant cavities;
a pressure side coversheet overlying the pressure side wall, an inner surface of the pressure side coversheet being in contact with the raised features on the outer surface of the pressure side wall, thereby defining pressure side flow pathways between the pressure side wall and the pressure side coversheet, the pressure side flow pathways being in fluid communication with the one or more coolant cavities; and
a suction side coversheet overlying the suction side wall, an inner surface of the suction side coversheet being in contact with the raised features on the outer surface of the suction side wall, thereby defining suction side flow pathways between the suction side wall and the suction side coversheet, the suction side flow pathways being in fluid communication with the one or more coolant cavities,
wherein the raised features on the outer surface of the pressure side wall and/or the suction side wall include an arrangement of pedestals, each pedestal comprising an aspect ratio in a range from 1:1 to 5:1, the pedestals in the arrangement having a cross-sectional shape selected from the group consisting of hexagonal and hexangular, and
wherein the aspect ratio of the pedestals is varied within the arrangement.

2. (canceled)

3. The airfoil of claim 1, wherein the arrangement of pedestals is on the outer surface of the pressure side wall.

4. The airfoil of claim 1, wherein the arrangement of pedestals is on the outer surface of the suction side wall.

5. The airfoil of claim 1, wherein the aspect ratio increases and/or decreases across the arrangement.

6. The airfoil of claim 1, wherein the aspect ratio is varied along a chordal direction.

7. The airfoil of claim 1, wherein the aspect ratio is varied along a radial direction.

8. The airfoil of claim 1, wherein the aspect ratio is varied along a direction having a chordal component and a radial component.

9. The airfoil of claim 1, wherein the aspect ratio decreases toward a midspan of the airfoil.

10. The airfoil of claim 1, wherein the aspect ratio increases toward a trailing edge and/or a leading edge of the airfoil.

11. The airfoil of claim 1, wherein long axes of the pedestals are aligned with a direction of coolant flow over the respective outer surface.

12. The airfoil of claim 1, wherein long axes of the pedestals are aligned with a chordal direction.

13. The airfoil of claim 1, wherein long axes of the pedestals are aligned with a radial direction.

14. The airfoil of claim 1, wherein long axes of the pedestals are aligned with a direction having a chordal component and a radial component.

15. The airfoil of claim 1, wherein a midspan cooling circuit configured to deliver coolant to the leading edge of the airfoil includes the arrangement of pedestals.

16. The airfoil of claim 15, wherein the arrangement of pedestals extends over an entirety of the midspan cooling circuit.

17. The airfoil of claim 15, wherein the arrangement of pedestals extends over just part of the midspan cooling circuit and is separated from a section of raised features positioned nearer to the leading edge by a radial spacing on the respective outer wall.

18. The airfoil of claim 15, wherein the arrangement of pedestals is adjacent to a trailing edge cooling circuit configured to deliver coolant to the trailing edge of the airfoil, wherein the raised features of the trailing edge cooling circuit comprise rails.

19. The airfoil of claim 1, wherein the arrangement of pedestals extends over an entirety of the pressure side wall and/or the suction side wall.

20. A gas turbine engine including the airfoil of claim 1.
